(19) United States
(12) Patent Application Publication
(10) Pub. No.: US 2002/0130817 A1
(43) Pub. Date: Sep. 19, 2002

(54) Communicating with stackable objects using an antenna array

(76) Inventors: Ian J. Forster, Glen Ellyn (GB); Michael G. Ginn, Essex (GB); Patrick F. King, Glen Ellyn, IL (US)

Correspondence Address: WITHROW & TERRANOVA, P.L.L.C., P.O. BOX 1287, CARY, NC, 27512, US

(21) Appl. No.: 09/810,858

(22) Filed: Mar. 16, 2001

(51) Int. Cl. H01Q 13/10

(52) U.S. Cl. 343/770

(57) ABSTRACT

The present invention relates to a transmission device that is coupled to an antenna array on a transportation device to wirelessly communicate with stacked objects and or devices containing wireless communication devices during their transport and/or storage. The transportation device contains a moveable member that may be lowered or raised to move and/or store stacked objects. The transmission device is placed on the moveable member and is coupled to an antenna array on the moveable member to selectively communicate with the stacked objects individually. The transmission device also uses an antenna array or proximity sensors to determine the height and/or number of stacked objects on the moveable member and to determine if a wireless communication device on a stacked object is operational.

### FIELD OF THE INVENTION

The present invention relates to an antenna array that is used to communicate with stackable transport structures containing a wireless communication device.

### BACKGROUND OF THE INVENTION

It is commonplace to track goods, objects and other articles of manufacture during the manufacturing and distribution process. It is also commonplace to provide communication systems for retrieval of information about goods, such as their identification number, expiration date, “born on” date, lot number, and the like. Some communication systems employ optical technology, like a bar code label and scanner, to track and communicate information concerning goods. For example, bar code labels may be placed on the goods, and optical readers may be placed along the route of the goods in the manufacturing and distribution supply chain to read the bar code labels for identification and tracking of the goods.

Some manufacturers have moved from optical systems to radio-frequency systems for tracking and identification of goods. Radio-frequency systems communicate identification and tracking information through radio-frequency communication signals as opposed to light signals used in optical systems. Radio-frequency systems are not dependent on the same obstacles that are present in optical systems, such as line of sight communications, label integrity, and environmental light interferences.

Some manufacturing and distribution facilities use transport structures, such as stackable objects, to transport and store goods. It may be desirable to track these stackable objects as well as the goods that are transported in these stackable objects, especially since a stackable object may contain goods that are all of the same type and/or characteristics. This may save communication time and energy since goods in a stackable object may all have the same information. Stackable objects, such as pallets, can be equipped with a wireless communication device, such as a radio-frequency identification device (RFID), that is interrogated for information by interrogation readers or other transmission equipment for the retrieval of information concerning the transported and/or stored goods. Since it is desired for these readers to have a limited range of communication so that tracking of stackable objects can be accomplished in a more precise fashion, these readers must be placed in abundance in all possible transportation paths of the stackable objects, thereby adding larger infrastructure costs to implementation of this communication system. Placement of a large volume of readers may also take up valuable space in manufacturing and distribution facilities that is desired for other purposes. In addition, a power network may be required to provide power to each individual reader thereby adding even further infrastructure costs.

Therefore, there exists a need to provide a more cost effective manner of providing readers in manufacturing and/or distribution facilities to communicate with stackable objects to retrieve information about goods that are transported and/or stored by such stackable objects.

### SUMMARY OF THE INVENTION

The present invention is directed to a device, system and method of wirelessly communicating with stackable objects transporting and/or storing articles of manufacture using an antenna array. The antenna array is placed on a transportation device in the same orientation as the objects that are stacked on the transportation device. The transportation device may be a forklift truck, crane or other object that can move stackable objects, such as pallets.

An interrogation reader is coupled to the antenna array and is capable of selectively exciting one or more individual antennas in the antenna array. The antennas in the antenna array can communicate with stacked objects individually to determine useful information about the stackable object and/or the goods in the stacked object. The antenna array may be comprised out of two or more pole antennas or two or more non-conductive slots in a conductive section to form two or more slot antennas. The antenna array may be included in a transparent medium so that the view of transportation device operator is not obstructed.

In one embodiment, the antenna array is a slot array comprised of nonconductive slots placed into a conductive section. The interrogation reader is coupled to the edge of the slots, and each of the slots are individually excited to form a slot antenna in locations where stacked objects would be present if stacked to the height of the slots. Notably, multiple slots may correlate with a given object.

In another slot array embodiment, the antennas that form the array are formed inside a transparent sheet. The sheet has a grid of fine wires. Links in the grid are removed are various positions to form slots.

In another antenna array embodiment, the antennas are formed using half-wave dipole antenna on the surface of a transparent sheet. The dipole antennas are formed using thin strips of metal.

In another dipole antenna array embodiment, the antennas are placed on flat, thin horizontal slats that are separate by air. The slats are also made of a transparent material. In this manner, the operator's view is substantially unobstructed since his view is only partial blocked by the thin slats.

In another embodiment, stacked objects are physically detected before wireless communication is initiated. The slot array is used in one aspect to determine if an object is stacked adjacent to the slot. The individual slots are excited using low power, and the power received is analyzed to determine if it was reflected by a stackable object located adjacent the slot. In another aspect, proximity sensors located adjacent the slots in the slot array are used to determine if an object is stacked in a given location.

In another embodiment, an interrogation reader determines the height of stacked objects being transported. The height of stacked objects may be useful information needed by the transportation device. For example, the transportation device may have certain restrictions concerning weight of the stackable objects, and the height may be useful in calculating in the weight. The height of stacked objects may also be useful for other purposes, such as verifying that all of the expected objects are present.

In another embodiment, the interrogation reader determines if a wireless communication device on a stackable object is inoperable. The interrogation reader attempts to communicate with the stacked object containing a wireless communication device after the stacked object is physically detected. If the wireless communication device does not respond to communication, it is inoperable.

The interrogation reader may communicate an error condition, inoperability or communication information concerning the goods and/or stackable objects to another system located in close proximity to the interrogation reader, to a remote system, or to both.

### BRIEF DESCRIPTION OF THE DRAWINGS

FIG. 1 is a schematic diagram of an interrogation reader and wireless communication device system in the prior art;

FIG. 2 is a schematic diagram of a forklift truck that has an interrogation reader and is capable of carrying and transporting stacked pallets containing wireless communications devices;

FIG. 3 is a schematic diagram of a forklift arm having a slot array coupled to the interrogation reader to form a plurality of slot antennas;

FIG. 4 is a schematic diagram of the dimensions of a slot array according to one embodiment of the present invention to form quarter or half wavelength antennas;

FIG. 4A is a cross-sectional view of an alternative embodiment of an antenna according to the concepts the present invention;

FIG. 5 is a schematic diagram of an interrogation reader and switch to selectively excite slots in a slot array that also contains proximity sensors for each slot;

FIG. 6A is a schematic diagram of a slot antenna array in a transparent sheet;

FIG. 6B is a schematic diagram of a half-wave dipole antenna array in a transparent sheet;

FIG. 6C is a schematic diagram of a dipole antenna array using thin slats;

FIG. 7 is a flowchart diagram of an interrogation system that excites the slot array with low power to act as a proximity-sensing device for the detection of stackable objects such as pallets;

FIG. 8 is a schematic diagram of an error reporting system;

FIG. 9 is a flowchart diagram of an interrogation system that excites the slot array with low power to act as a proximity sensing device for the detection of stackable objects while also keeping the current height of stacked stackable objects; and

FIG. 10 is a flowchart diagram of an interrogation system that uses separate proximity sensors to determine if a pallet is present.

### DETAILED DESCRIPTION OF THE INVENTION

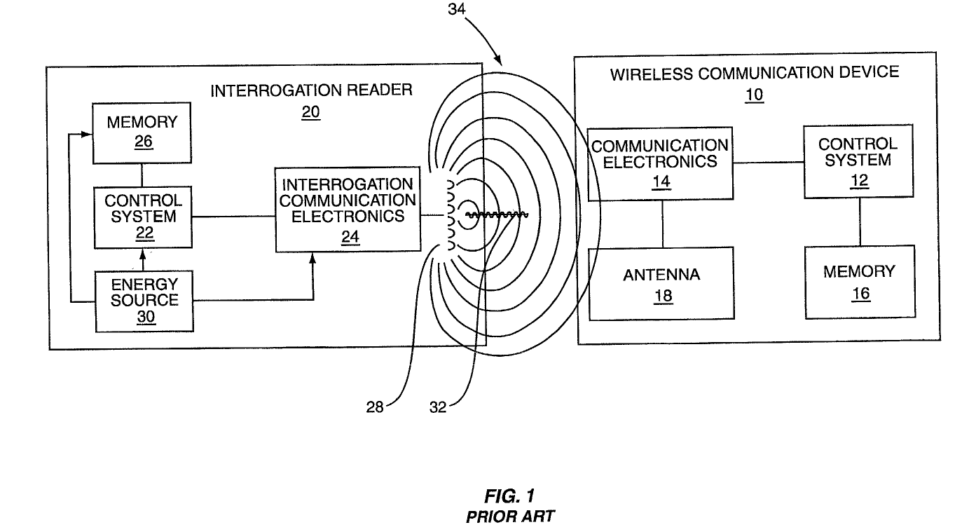

The present invention is directed to a device, system and method of wirelessly communicating with stackable objects transporting and/or storing articles of manufacture using an antenna array. The antenna array is placed on a transportation device in the same orientation as the objects that are stacked on the transportation device. An interrogation reader is coupled to the antenna array and is capable of selectively exciting one or more individual antennas in the antenna array. The antennas in the antenna array can communicate with stacked objects individually to determine useful information about the stackable object and/or the goods in the stacked object, such as the height of the stacked objects, and if any of the stacked objects has an inoperable wireless communication device. Referring now to the drawings in general, and to FIG. 1 in particular, it will be understood that the illustrations are for the purpose of describing specific embodiments of the present invention and are not intended to limit the invention thereto.

FIG. 1 illustrates a typical wireless communication device and communication system in the prior art. The wireless communication device 10 is capable of communicating information wirelessly and may include a control system 12, communication electronics 14, and memory 16. The wireless communication device 10 is also known as a radio-frequency identification device (RFID). The communication electronics 14 is coupled to an antenna 18 for wirelessly communicating information in radio-frequency signals. The communication electronics 14 is capable of receiving modulated radio-frequency signals through the antenna 18 and demodulating these signals into information passed to the control system 12. The antenna 18 may be internal or external to the wireless communication device 10.

The control system 12 may be any type of circuitry or processor that receives and processes information received by the communication electronics 14, including a micro-controller or microprocessor. The wireless communication device 10 may also contain a memory 16 for storage of information. Such information may be any type of information about goods or stackable objects, including but not limited to identification, tracking and other pertinent information. The memory 16 may be electronic memory, such as random access memory (RAM), read-only memory (ROM), flash memory, diode, etc., or the memory 16 may be mechanical memory, such as a switch, dip-switch, etc.

Some wireless communication devices 10 are termed “active” devices in that they receive and transmit data using their own energy source coupled to the wireless communication device 10. A wireless communication device may use a battery for power as described in U.S. Pat. No. 6,130,102 entitled “Radio frequency data communications device,” or may use other forms of energy, such as a capacitor as described in U.S. Pat. No. 5,833,603, entitled “Implantable biosensing transponder.” Both of the preceding patents are incorporated herein by reference in their entirety.

Other wireless communication devices 10 are termed “passive” devices meaning that they do not actively transmit and therefore may not include their own energy source for power. One type of passive wireless communication device 10 is known as a “transponder.” A transponder effectively transmits information by reflecting back a received signal from an external communication device, such as an interrogation reader. An example of a transponder is disclosed in U.S. Pat. No. 5,347,280, entitled “Frequency diversity transponder arrangement,” incorporated herein by reference in its entirety. Another example of a transponder is described in co-pending patent application Ser. No. 09/678,271, entitled “Wireless Communication Device and Method,” incorporated herein by reference in its entirety.

FIG. 1 depicts communication between a wireless communication device 10 and an interrogation reader 20. The interrogation reader 20 may include a control system 22, an interrogation communication electronics 24, memory 26, and an interrogation antenna 28. The interrogation antenna 28 may be a pole antenna or a slot antenna. The interrogation reader 20 may also contain its own internal energy source 30, or the interrogation reader 20 may be powered through an external power source. The energy source 30 may include batteries, a capacitor, solar cell or other medium that contains energy. The energy source 30 may also be rechargeable.

The interrogation reader 20 communicates with the wireless communication device 10 by emitting an electronic signal 32 modulated by the interrogation communication electronics 24 through the interrogation antenna 28. The interrogation antenna 28 may be any type of antenna that can radiate a signal 32 through a field 34 so that a reception device, such as a wireless communication device 10, can receive such signal 32 through its own antenna 18. The field 34 may be electromagnetic, magnetic, or electric. The signal 32 may be a message containing information and/or a specific request for the wireless communication device 10 to perform a task or communicate back information. When the antenna 18 is in the presence of the field 34 emitted by the interrogation reader 20, the communication electronics 14 are energized by the energy in the signal 32, thereby energizing the wireless communication device 10. The wireless communication device 10 remains energized so long as its antenna 18 is in the field 34 of the interrogation reader 20. The communication electronics 14 demodulates the signal 32 and sends the message containing information and/or request to the control system 12 for appropriate actions.

It is readily understood to one of ordinary skill in the art that there are many other types of wireless communications devices and communication techniques than those described herein, and the present invention is not limited to a particular type of wireless communication device, technique or method.

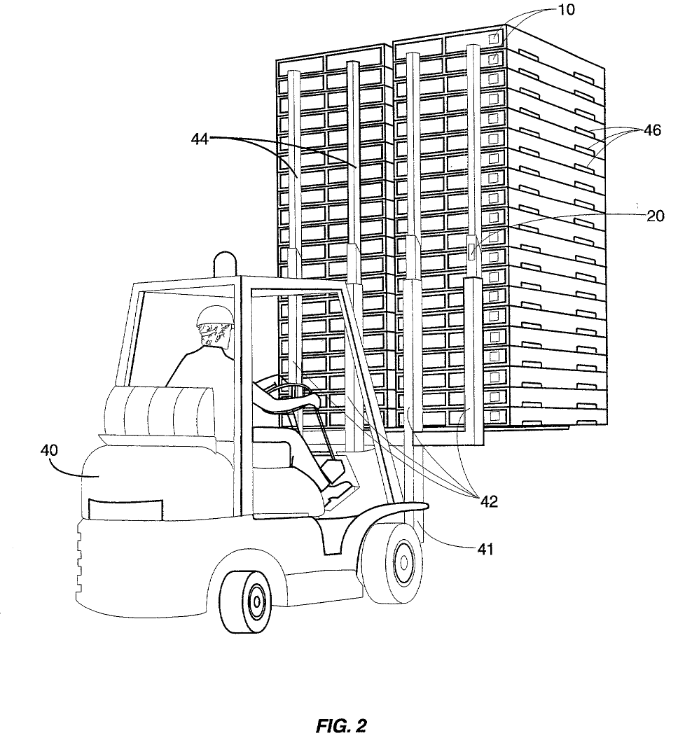

FIG. 2 illustrates one type of transportation device known as a forklift truck 40. The forklift truck 40 is often used to transport and store stacked objects commonly known as pallets 46. The forklift truck 40 contains members 42, 44 also known as arms that carry the pallets 46. A first arm 42 is fixed rigidly to the body 41 of the forklift truck 40. A second, moveable arm 44 is attached to the first arm 42, and the moveable arm 44 may be controlled to move with respect to the first arm 42. The pallets 46 are stacked on the moveable arm 44 and may be transported and raised or lowered for storing. The first arm 42 may be comprised of more than a single arm, and the moveable arm 44 may be comprised of more than a single arm depending on the size and characteristics of the forklift truck 40. The forklift truck 40 illustrated in FIG. 2 contains four fixed arms 42 and four moveable arms 44 for lower and raising the pallets 46.

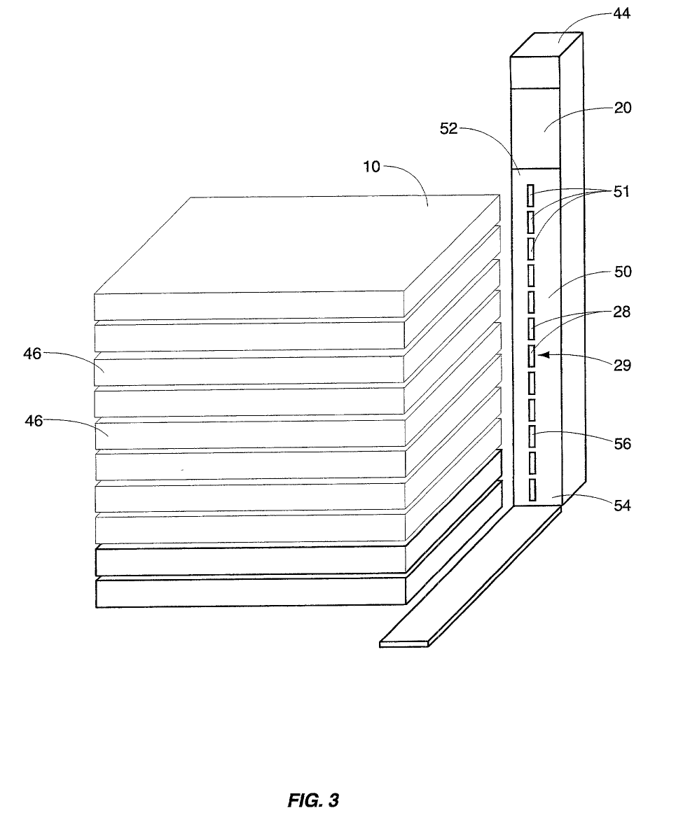

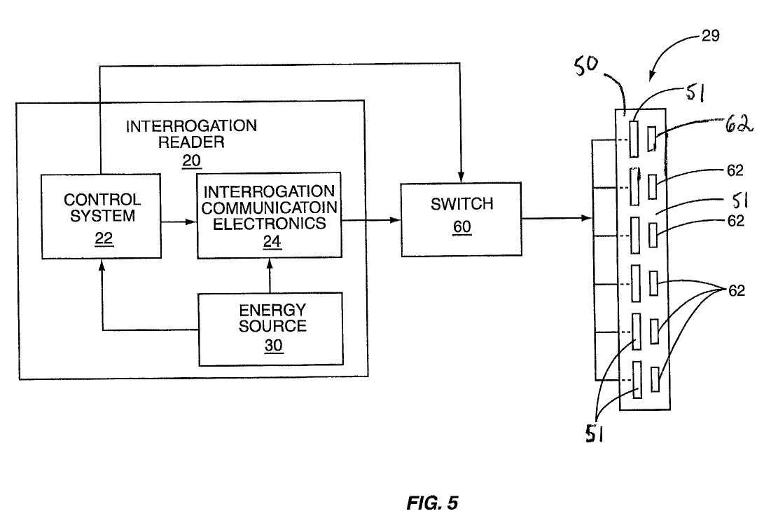

The forklift truck 40 also contains an interrogation reader 20 for communication with the individual wireless communication devices 10 on the pallets 46. The interrogation reader 20 is coupled to an antenna array 29 (illustrated in FIG. 3) that contains individual antennas 28 that are placed in the same direction as the pallets 46 are stacked on the moveable arm 44 so that each antenna 28 is located adjacent to pallets 46 that are stacked on the moveable arm 44. In this manner, the interrogation reader 20 may individually communicate with pallets 46 stacked on the moveable arm 44. Using individual antennas 28 for each of the pallets 46 as opposed to a single antenna 28 allows certain advantages that are the subject of the present invention. These advantages include the interrogation reader's 20 ability to determine the height of the stacked pallets 46 and to determine if a wireless communication device 10 on a particular pallet 46 is inoperable. These advantages of the present invention are expanded upon below in FIGS. 5-9.

The interrogation reader 20 is attached on the moveable arm 44 so that it moves with the antenna array 29 when the moveable arm 44 is raised or lowered. This allows fixed lengths of wire or other coupling devices to be used to couple the antennas 28 in the antenna array 29 to the interrogation reader 20. If the interrogation reader 20 is attached to the static arm 42 or the body 41, flexible couplings would have to be used to couple the interrogation reader 20 to the antennas 28 since the antennas 28 would move farther or closer away from the interrogation reader 20 when the moveable arm 44 was raised or lowered respectively. Placing the interrogation reader 20 on the moveable arm 44 reduces the possibility of tangling and/or severing of the couplings connected to the antennas 28.

FIG. 3 illustrates a more detailed view of the moveable arm 44 and the pallets 46. The moveable arm 44 is L-shaped, and the pallets 46 are stacked in a vertical direction onto the moveable arm 44. The moveable arm 44 contains the interrogation reader 20 and the antennas 28 for communication to the wireless communication devices 10 that are attached to the pallets 46. The antennas 28 illustrated in this particular embodiment are formed from a slot array 29. The slot array 29 is comprised of a conductive section 50 that contains an array of two or more individual slots 51 aligned in the same direction as the stacked pallets 46. The interrogation communication electronics 24 of the reader 20 is coupled to the edge of the slots 51 in the slot array 29. When the interrogation reader 20 excites a particular slot 51, the slot forms a slot antenna to radiate the signal 32 for external communication. Note that the antenna array 29 may be comprised out of individual pole antennas 28, such as dipole antennas, and the antenna array 29 is not limited to a slot array.

The slot array 29 comprises a conductive section 50 that has an upper end 52 and a lower end 54 and is constructed out of metal, steel, aluminum or other conductive material. The slots 51 are located within the conductive section 50 and are comprised out of non-conductive material that may include air, plastic, epoxy or other non-conductive material. The interrogation reader 20 is coupled to each of the slots 51 so that each of the slots 51 may be individually excited to form a slot antenna 28. More information on a slot antennas and their operation in general is discussed in U.S. Pat. No. 4,975,711, entitled “Slot antenna device for portable radiophone,” incorporated herein by reference in its entirety.

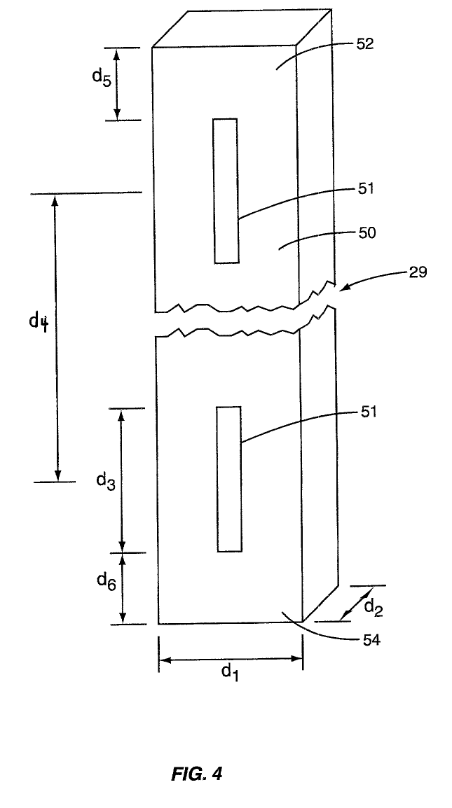

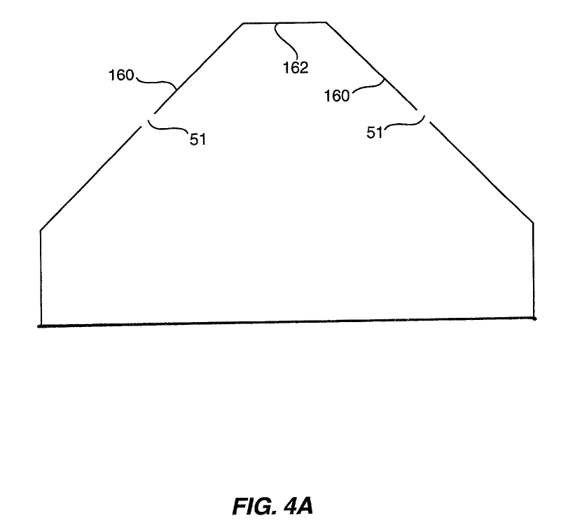

FIG. 4 illustrates configuration of the slot array 29 illustrated in FIG. 3 that forms a quarter (or half) wavelength antenna at an operating frequency around about 915 MHz. For this embodiment, the conductive section 50 is approximately 164 millimeters in width (d₁,) and 82 millimeters deep (d₂). Two or more slots 51 are aligned vertically in the conductive section 50. Each slot 51 is approximately 164 millimeters in length (d₃). Notably the d₂ and d₃ dimensions have the most impact on the antenna performance and tuning. The depth (d₂) and in length (d₃) of the slot 51 will depend on the dielectric constant of the conductive section. The distance between the center of adjacent slots 51 is approximately 328 millimeters (d₄). The edge of the slot 51 located nearest the top end 52 of the conductive section 50 and the edge of the slot 51 located nearest the bottom end 54 of the conductive section 50 are preferably at least 50 millimeters from the top end 52 (d₅) and the bottom end 54 (d₆) respectively; however, those skilled in the art will recognize the position will depend on the application. If an operating frequency of 868 MHz is desired, the width of the conductive section 51 (d₁) may be set at 86.3 millimeters and the depth of the conductive section 51 (d₂) may be set at 172.3 millimeters. Notably, the metal immediately around and forming the slots 51 should be continuous and of sufficient width to ensure the resultant antenna works properly. Each of the slots 51 may be formed in a separate plate wherein the plates are aligned to form the slot array 29. The plates may be attached to one another with flexible or bendable joints to provide resiliency to external forces or impacts. Further, any or all of the slot array 29 may be covered or encapsulated with a resilient material, such as a high impact silicone rubber, for additional protection.

The present invention involves the ability of the interrogation reader 20 to selectively excite one more of the slots 51 in the slot array 29. The slots 51 are aligned in the slot array 29 on the conductive section 50 at locations substantially equal to the width of the stacked pallets 46; however, the slots 51 may be aligned in any manner desired. For example, there may be more slots 51 than potential pallets 46, and the slots 51 may be staggered to improve performance.

Assume for example that the number of slots 51 in the slot array 29 is equal to the maximum number of pallets 46 that may be stacked on the moveable arm 44 so that an individual slot 51 in the slot array 29 may be used by the interrogation reader 20 to knowingly communicate with a particular pallet 46 stacked on the moveable arm 44. The interrogation reader 20 may then be able to determine the height of the stacked pallets 46 and determine if the wireless communication device 10 on a particular pallet 46 is operational and otherwise communicate and exchange information with the wireless communication device 10 on a particular pallet 46.

For example, if interrogation reader 20 wants to communicate specifically with the third pallet 46 stacked on the moveable arm 44, the interrogation reader 20 excites the slot 51 that is adjacent to where the third pallet 46 is expected so as to form a slot antenna 28. The interrogation reader 20 receives a communication signal from a wireless communication device 10 on the third pallet 46 to receive specific information about the third pallet 46 and/or its goods. Reception of a return signal for the wireless communication device 10 on the third pallet 46 also indicates that the wireless communication device 10 on the third pallet 46 is operational. The control system 22 may excite other slots 51 in the same manner to determine the number or height of pallets 46 stacked on the moveable arm 44.

There are different techniques and methods in which the interrogation reader 20 may determine the number or height of stacked pallets 46 on the moveable arm 44 and if a wireless communication device 10 on a particular pallet 46 is operational. For example, multiple slots 51 in the slot array 29 may be roughly proximate and correspond with a given pallet 46, since difference pallets 46 (or other objects or goods) may have different heights or thickness. In such an embodiment, multiple slots 51 may facilitate communications with a given wireless communication device 10. Since there is no guarantee a pallet 46 is directly in front of or aligned with the wireless communication device 10, readings from the wireless communication device 10 may be taken using multiple slots 51 wherein the slot 51 associated with the strongest return signal is most likely most proximate the wireless communication device 10. If a first slot 51 is associated with a first signal corresponding to 40% of a maximum signal strength, a second slot 51 is associated with a second signal corresponding to 75% of the maximum signal strength, and a third slot 51 is associated with a third signal corresponding to 55% of the maximum signal strength, the wireless communication device 10 is most likely most proximate the third slot 51.

The present invention may use the techniques illustrated and discussed in FIGS. 5-10 for the above referenced purposes, but the present invention is not limited to these particular techniques. FIG. 5 illustrates one embodiment of an interrogation reader 20 that is capable of selectively exciting one or more slots 51 in the slot array 29. The control system 22 is coupled to interrogation communication electronics 24 for external communications. A switch 60 is provided between the interrogation communication electronics 24 and the slot array 29. The switch 60 may be any type of switch 60 that is electronically controllable. The switch 60 is coupled to the slots 51 in the slot array 29 to selectively direct energy from the interrogation communication electronics 24 to the particular slot 51 desired. The control system 22 is also coupled to the switch 60 to control the switch 60, thereby selecting the particular slot 51 in the slot array 29 that receives energy from the interrogation communication electronics 24.

Alternatively, the slots 51 in the slot array 29 may be individually addressable using a printed circuit board (PCB) and a data bus (not shown). Each of the slots 51 may be controlled by a PCB that is addressable by the control system 22 through an interrupt signal, input and output signal or addressing scheme such as a parallel address and data bus scheme commonly used in microprocessor designs. The PCBs may be memory-mapped or may be individually controlled through output ports controlled by the control system 22. The PCBs may be configured to only respond and thereby allow energy from the interrogation communication electronics 24 to excite an individual slot 51 if a particular address is communicated.

Proximity sensors 62 may also be used in conjunction with the slot array 29 for detection of pallets 46 stacked on the moveable arm 44. Proximity sensors 62 are located proximate to each of the slots 51 in the slot array 29. The proximity sensors 62 allow the control system 22 to determine if a pallet 46 is physically present on the moveable arm 44 before communication is established. If a pallet 46 is physically present, but the control system 22 is unable to establish communication with the wireless communication device 10 on the pallet 46 through excitation of the slot 51 aligned with the pallet 46, this is an indication that the wireless communication device 10 is inoperable and should be repaired or replaced.

Even though separate proximity sensors 62 may be used with the present invention to determine if a pallet 46 is present before communication is attempted, the present invention may also use the slot array 29 for this same purpose. One aspect of the present invention involves the interrogation reader 20 selectively exciting slots 51 in the slot array 29 with a lower power signal 32 to first determine if any pallets 46 have been stacked on the moveable arm 44. A lower power signal 32 may be used to allow the interrogation reader 20 to save energy from its energy source 30 by first detecting if a pallet 46 containing a wireless communication device 10 is present. If one or more pallets 46 have been detected, the interrogation reader 20 then uses a higher power signal 32 to communicate with the wireless communication devices 10 on the pallets 46.

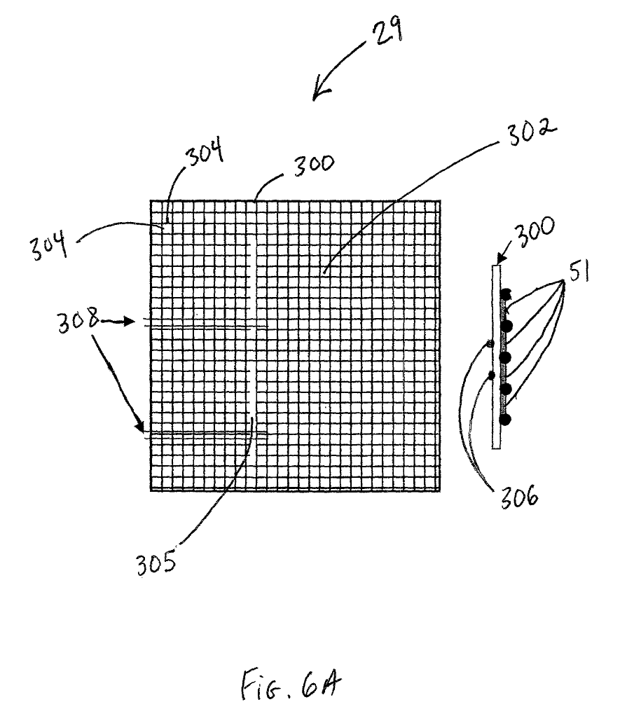

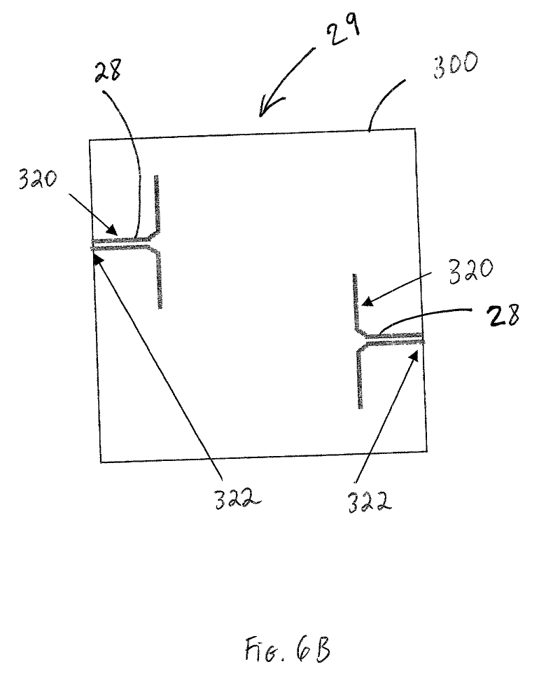

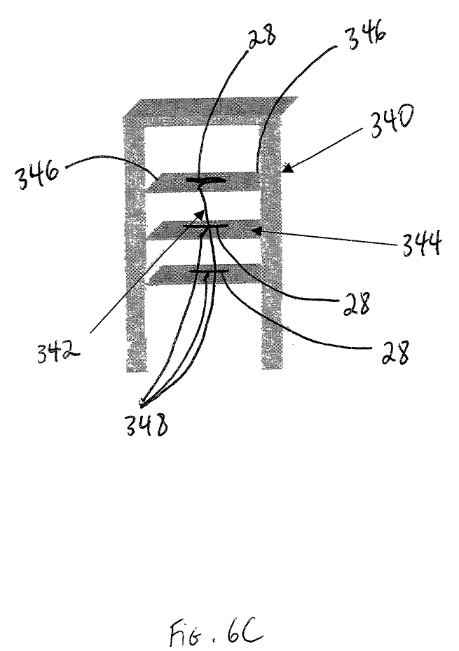

FIGS. 6A-6C illustrate alternative embodiments of antenna arrays 29 that may be used with the present invention. FIG. 6A illustrates a transparent sheet 300 that may be used to house the slot array 29. Use of a transparent sheet 300 may be useful if the slot array 29 is placed in front of the transportation device 40 so that the slot array 29 does not obstruct the view of the transportation device 40 operator. The transparent sheet 300 may be made of glass, polycarbonate, or polymethylmethacrylate. The sheet 300 has a grid 302 of fine wires 304 inside. At various positions, links in the grid 302 are removed 305 to form slots 51, which are coupled to a pair of thin wires 306 on the opposite side of the sheet 300 separate by a dielectric 300 acting as a coplanar wave guide transmission line. The slots 51 are coupled to feed points 308 mounted to the edge of the grid 302 which are then coupled to switch 60 and/or the interrogation reader 20 so that the antennas 28 may be selectively excited.

FIG. 6B illustrates another antenna array 29 embodiment using dipole antennas 28. A transparent sheet 300 is provide similar to the sheet 300 illustrated in FIG. 6A. However, dipole antennas 28 are placed inside the sheet 300 to form the antenna array 29. In this embodiment, the dipole antennas 28 have quarter wavelength arms 320 and are half wavelength antennas overall. The dipole antennas 28 are connected to the edge 322 of the sheet 300 so that they may be coupled to switch 60 and/or the interrogation reader 20 to be selectively excited.

FIG. 6C illustrates another antenna array 29 embodiment using dipole antennas 28 as well. A cabin 340 having a hollow inside 342 is provided. Dipole antennas 28 are placed individually inside flat, thin slats 344 inside the cabin 340. The slats 344 are connected to each side of the inner portion 346 of the cabin 340 for support. The slats 344 may be transparent so that the view of the transportation device 40 operator is less obstructed. The dipole antennas 28 are coupled to the switch 60 and/or the interrogation reader 20 to be individually excited at the edge 348 of the slat 344 where a portion of the dipole antenna 28 is exposed outside the slat 344.

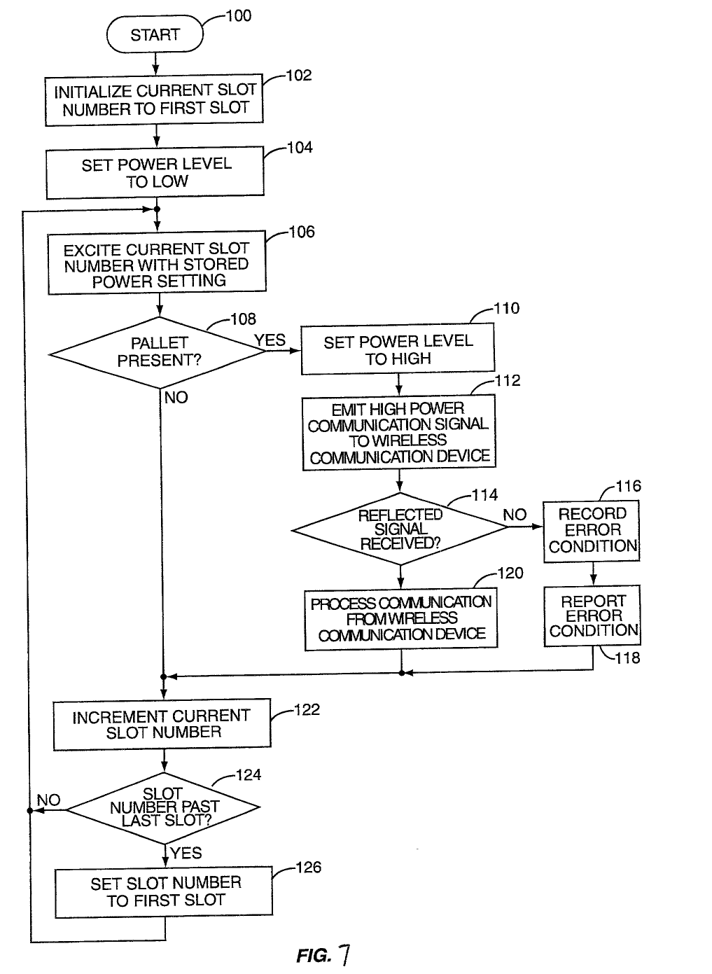

One embodiment of the above referenced process is illustrated in the flowchart in FIG. 7. The process starts (block 100), and control system 22 first performs some initializations. The control system 22 initializes a current slot number in memory 26 that is to be selectively excited by the interrogation reader 20 during the process (block 102). The control system 22 next sets the power level of the signal 32 to be emitted by the interrogation communication electronics 24 to low power (block 104). Low power, for example, may be one milliWatt. The control system 22 excites the slot 51 of the current slot number stored in memory 26 (block 106). During the first execution of the process, the current slot number is the first slot 51.

The control system 22 determines if a pallet 46 is present at the location of the current slot number (decision 108). The control system 22 measures the reflected energy from the lower energy signal 32 to determine if a pallet 46 is present in front of the excited slot 51 selected. Each slot 51 has a forward and reverse power coupler in it. The interrogation reader 20 can determine if a pallet 46 is located adjacent to a slot 51 due to the pallet 46 detuning the antenna 28 formed by exciting the slot 51 and increasing the reverse power measured. If a pallet 46 is present, the ratio of the power of reflected signal to the power of emitted signal will be much higher than if a pallet 46 is not present. If the signal 32 is reflected in such a manner that indicates an object is in front of the current slot number at an expected close range, this indicates to the control system 22 that a pallet 46 is closely positioned in front of the current slot number.

In another embodiment that allows the slot array 29 to be used to sense the presence of pallets 46, two slots 51 in different planes or with complementary orientations are used at each position in the slot array 29 where one slot 51 is illustrated in FIG. 3. An example is shown in cross-section in FIG. 4A. In this example, two angled faces 160 are shown including slots 51. The angle faces 160 are separated by a front face 162 and form 45-degree angles with the front face 162. Having angled faces allows directing radiation lobes in corresponding angels to improve coverage by providing radiation lobes to extend in different directions. In contrast, two or more slots 51 may be configured to overlap a common region to minimize potential obstruction. Although two faces are depicted, any number of faces is applicable.

If a pallet 46 is present in front of the current slot number, the control system 22 sets the power level of the signal 32 to be emitted by the interrogation communication electronics 24 to a higher power level for communications, such as one Watt (block 110). The control system 22 directs the interrogation communication electronics 24 to emit another signal 32 at the higher power level to the pallet 46 to establish communication with its wireless communication device 10 (block 112).

The control system 22 determines if the signal 32 was successfully received by the wireless communication device 10 by waiting for a reflected version of the signal 32 (decision 114). If the signal 32 was not reflected, thereby indicating that the wireless communication device 10 on the pallet 46 is inoperable or some other communication problem exists, the control system 22 may record an error condition in memory 26 indicating that communication with the pallet 46 stacked at the location of the current slot number is inoperable (block 116). The control system 22 may also report this error condition to another system that may be another computer system located in close proximity to the interrogation reader 20, or to a computer system that is located remotely from the interrogation reader 20, or both (block 118).

If the control system 22 receives the reflected signal 32 from the wireless communication device 10, this indicates that the wireless communication device 10 on the pallet 46 located at the current slot number is operational, and the control system 22 processes the communication as normal (block 120). After either a successful or non-successful communication (block 120 or blocks 116 and 118, respectively), the process increments the current slot number to the next slot number (block 122). If the current slot number is greater than the last slot in the slot array 29 (decision 124), the control system 22 resets the current slot number to the first slot (block 126) and the process repeats by exciting the current slot number to determine if a pallet 46 is present at the new current slot number (block 106).

If the current slot number after the increment step (block 122) is less than or equal to the last slot in the slot array 29 (decision 124), the current slot number is not reset, and the process repeats by exciting the current slot number to determine if a pallet 46 is present (block 106).

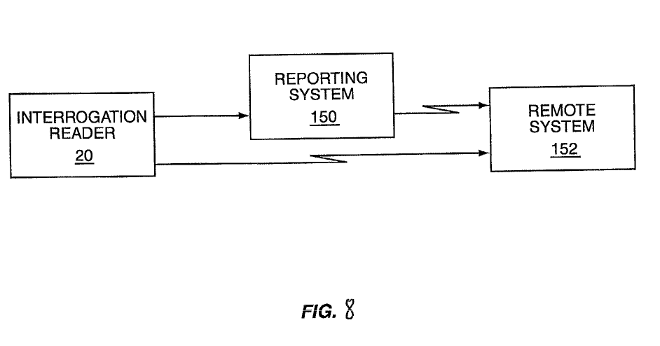

FIG. 8 illustrates a block diagram of the error reporting for the present invention from FIG. 7 (block 118). The interrogation reader 20 may be coupled to a reporting system 150. This reporting system 150 may be located in close proximity to the interrogation reader 20, and may be coupled to the interrogation reader 20 by either a wired or wireless connection. The reporting system 150 may be a user interface or other computer system that is capable of recording and indicating an error condition. The reporting of the error condition may be used to alert personnel to replace or repair the inoperable wireless communication device 10 on a pallet 46.

The reporting system 150 may also report the error condition to a remote system 152 located remotely from the reporting system 150 and/or the interrogation reader 20. The communication between the reporting system 150 and the remote system 152 may be through wired communication, modem communication or other networking communication, such as the Internet. Alternatively, the interrogation reader 20 may communicate the error condition directly to the remote system 152 rather than first reporting the error condition through the reporting system 150 using the same or similar communications as may be used between the reporting system 150 and the remote system 152. Also note that the interrogation reader 20 may also communicate information to the reporting system 150 and the remote system 152 relating to information regarding pallets 46 and information received from wireless communication devices 10 on pallets 46, even if an error condition is not present.

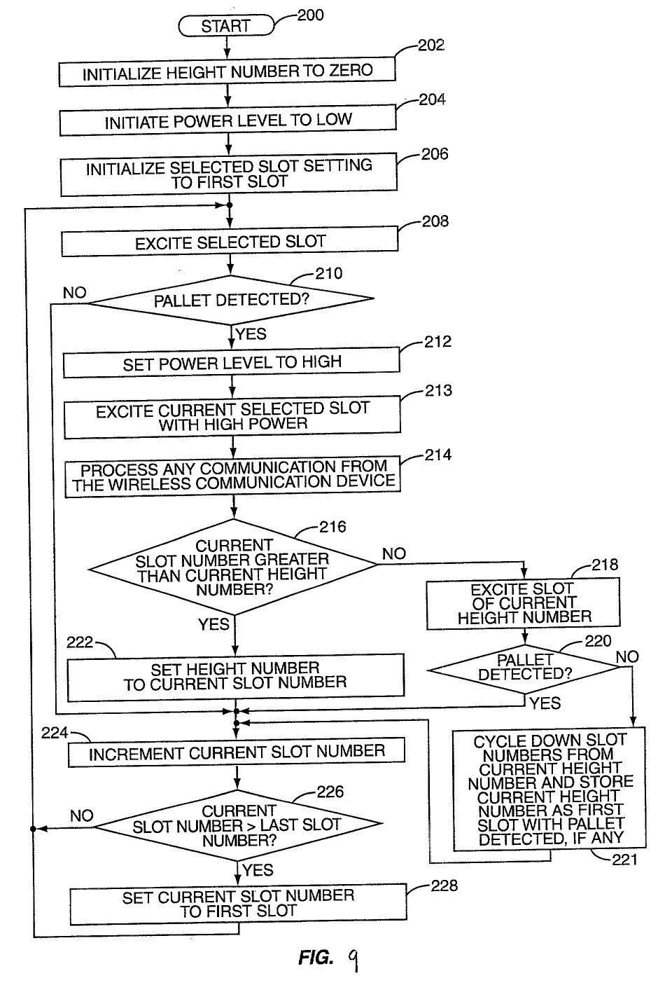

FIG. 9 illustrates another embodiment of the present invention whereby the control system 22 uses the slot array 29 both as a proximity-sensing device and as a communication device for stacked pallets 46, just as in FIG. 7. However, the control system 22 additionally keeps track of the current height of the stacked pallets 46 on the moveable arm 44. In this manner, the number of pallets 46 may be stored in memory 26, and the interrogation reader 20 may choose to only emit a high power communication signal 32 after a complete scan is performed to save energy.

The process starts (block 200), and the control system 22 initializes a current height number in memory 26 to zero (block 202). The control system 22 initializes the power level to low in memory 26 that is used by the interrogation communication electronics 24 to set the power to be used for emitting the signal 32 (block 204). The control system 22 also initializes the current selected slot 51 to be excited by the interrogation reader 20 to the first slot 51 in the slot array 29 (blocks 206 and 208). Just as described in FIG. 7, the interrogation reader 20 determines if a pallet 46 is located adjacent to the current selected slot 51 (decision 210). If a pallet 46 is not detected, the control system 12 increments the current slot number (block 224). If the current slot number is less than or equal to the last slot number present in the slot array 29, the process repeats by exciting the new current slot number (block 208). If the current slot number is greater than the last slot number present in the slot array 29, the control system 12 reinitializes the current slot number to the first slot (block 228), and the process repeats by exciting the new current slot number (block 208).

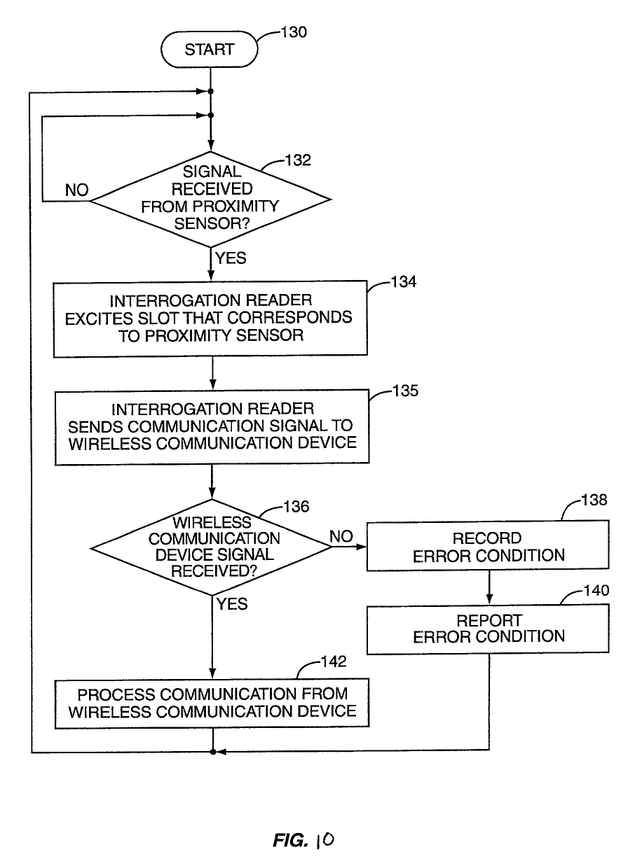

If a pallet 46 is detected by the control system 22 (decision 210), the control system 22 sets the power level setting in memory 26 to high (block 212) and excites the current selected slot again with high power to send out the signal 32 (block 213). The control system 22 processes any received communication from the wireless communication device 10 on the pallet 46 (block 214). If the current slot number is greater than the current height number (decision 216), the current height number is set to the current slot number (block 222) to update the current height of the stacked pallets 46 on the moveable arm 44. If the current slot number is not greater than the current height number (decision 216), the control system 22 determines if there is still a pallet 46 present at the current height number by exciting the slot number of the current height number stored in memory 26 (block 218). If a pallet 46 is not detected at the stored current height number, the control system cycles down through lower slots 51 in the slot array 29 one at a time until a slot 51 is excited that also contains an adjacent pallet 46 (block 221). The control system 22 then stores the current height number as equal to the next detected pallet 46 by the interrogation reader 20 (block 221). The control system 22 next increments the current slot number in memory 26 regardless of if a pallet is detected (decision 220), and the process continues on as previously described (block 226 et al.). If a pallet 46 had been detected at the stored height number (block 220), then likewise the control system22 would have incremented the current slot number 26 (block 224), and the process would have continued on as previously described (block 266 et al.) FIG. 10 illustrates another embodiment of the present invention whereby separate proximity sensors 62 are placed adjacent to each of the slots 51 in the slot array 29. In this matter, the control system 22 uses the signal from the proximity sensor 62 to indicate whether or not a pallet 46 is present at the location of the proximity sensor 62 and adjacent slot 51. Any type of proximity sensor may be used with this embodiment, including but not limited to an infrared emitter and/or detector, sonic emitter and/or detector, etc. This embodiment is similar to use of the slot array 29 to determine the presence of pallets 46 in FIGS. 7 and 9; however, the use of proximity sensors 62 allows the control system 12 to remain dormant until a proximity signal is received rather than having to excite the slots 51 in a cyclical, polling-like fashion, so long as the control system 12 can determine which proximity sensor 62 sent a proximity signal.

The process starts (block 130), and the control system 22 determines if a signal has been received from a proximity sensor 62 located adjacent the slots 51 in the slot array 29 (decision 132). If the control system 22 does not receive a signal from a proximity sensor 62, the process keeps repeating until a signal is received from a proximity sensor 62 (decision 132). If a signal is received from a proximity sensor 62 (decision 132), the interrogation reader 20 excites the particular slot 51 in the slot array 29 adjacent to the proximity sensor 62 that emitted the signal (block 134). The interrogation reader 20 next determines if the pallet 46 has an operational wireless communication device 10 by emitting a communication signal 32 (block 135) and waiting for its reflection from the wireless communication device 10 (decision 136).

If the reflection of the signal 32 was not received by the interrogation communication electronics 24, this indicates that the wireless communication device 10 on the pallet 46 stacked adjacent to the excited slot 51 is inoperable. The error condition is recorded by the control system 22 (block 138), and may be recorded in memory 26. The error condition may also be reported by the control system 22 to another system (block 140), such as a reporting system 150 or a remote system 152, just as previously described in FIGS. 7 and 8. The process repeats by the control system 22 waiting for the next proximity sensor 62 signal to be received (decision 132).

If the interrogation communication electronics 24 receives a reflection of the signal 32, this indicates that the wireless communication device 10 on the pallet 46 located adjacent to the excited slot 51 is operational (decision 136). The communication received from the wireless communication device 10 is processed by the control system 22 in a normal manner (block 142), and the process returns back to the control system 22 waiting for the next proximity sensor 62 signal to be received (decision 132).

Certain modifications and improvements will occur to those skilled in the art upon a reading of the foregoing description. It should be understood that the present invention is not limited to any particular type of component including, but not limited, to the wireless communication device 10 and its components, interrogation reader 20 and its components, arms 42, 44, stackable objects, including pallets 46, slot antenna array 29 and the materials comprising its construction, switch 60, and proximity sensor 62. Any type of stackable object 46 may be used with the present invention including pallets, objects, etc. Any type of transportation device 40 may be used with the present invention, including a forklift truck, a crane, etc. Power and energy may be used interchangeably with the present invention, and the present invention is not limited to only power or energy in any embodiment if only one of these terms is used. For the purposes of this application, couple, coupled, or coupling is defined as either a direct connection or a reactive coupling. Reactive coupling is defined as either capacitive or inductive coupling.

One of ordinary skill in the art will recognize that there are different manners in which these elements can accomplish the present invention. The present invention is intended to cover what is claimed and any equivalents. The specific embodiments used herein are to aid in the understanding of the present invention, and should not be used to limit the scope of the invention in a manner narrower than the claims and their equivalents.

What we claim is:

1. A slot antenna array that is excited by a communication signal to determine the number of stacked objects, comprising:
a conductive section having a top end and a bottom end; and
said conductive section having a plurality of slots substantially the same length and filled with a non-conductive material; and
said plurality of slots are individually excited with the communication signal to determine the number of the stacked objects.

2. The slot antenna array of claim 1, wherein said plurality of slots are spaced apart at equal distances from each other.

3. The slot antenna array of claim 1, wherein each of said plurality of slots are spaced apart at a distance substantially equal to the height of one of said stacked objects.

4. The slot antenna array of claim 1, wherein each of said plurality of slots is substantially the same in length as the width of said conductive section.

5. The slot antenna array of claim 1, wherein said non-conductive material is comprised from the group consisting of air and epoxy.

6. The slot antenna array of claim 1, wherein said conductive section has a width and a depth and said plurality of slots includes a bottom slot and a top slot that are located at a distance from said bottom end and said top respectively that is substantially the same said depth.

7. The slot antenna array of claim 6, wherein said depth is around about 82 millimeters and the width of said plurality of slots is around about 164 millimeters.

8. The slot antenna array of claim 7, wherein the width of each of said plurality of said slots is between about 3 millimeters and 10 millimeters.

9. The slot antenna array of claim 6, wherein said the length of each of said plurality of said slots is substantially the same in length as the width of said conductive section.

10. The slot antenna array of claim 1, wherein the operating frequency of said plurality of slots is comprised from the group consisting of around about 869 MHZ and 915 MHz.

11. The slot antenna array of claim 1, wherein at least two slots in said plurality of slots are each included in angled faces in said conductive section.

12. An interrogation reader and antenna system adapted to individually communicate with stacked objects, comprising:
an antenna array having a plurality of antennas;
a switch; and
a communication electronics that provides energy to said switch;
said switch coupled to said antenna array to selectively excite one or more of said antennas in said antenna array corresponding to select ones of said plurality of slots.

13. The interrogation reader of claim 12, wherein said antenna array is comprised of a slot array;

14. The interrogation reader of claim 13, wherein said slot array is formed by a conductive section filled having a plurality of slots filled with a non-conductive material.

15. The interrogation reader of claim 12, further comprising an energy source.

16. The interrogation reader of claim 15, wherein said energy source is rechargeable.

17. The interrogation reader of claim 12, further comprising a coaxial cable containing wire to coupled said switch to said antenna array.

18. The interrogation reader of claim 12, wherein said switch is comprised of a PCB that contains a communications port for controlling energy to said antenna array.

19. The interrogation reader of claim 12, further comprising a controller that is coupled to said switch to control the coupling of said energy to an antenna in said antenna array.

20. The interrogation reader of claim 19, wherein said controller further comprises a data bus that is connected to said antenna array to address each of said antennas in said antenna array individually to control which of said antenna are excited.

21. The interrogation reader of claim 12, wherein said switch is reactively coupled to said antenna array.

22. The interrogation reader of claim 19, wherein said controller causes said communication electronics to send lower power to said antenna array in a first mode to detect the presence of an external device and said controller causes said communication electronics to send high power to said antenna array in a second mode when a external device is detected to communicate with said external device.

23. The interrogation reader of claim 22, wherein said lower power is around about one milliWatt and said high power is around about one Watt.

24. The interrogation reader of claim 22, wherein said controller measures the energy received by said communication electronics in response to the energy transmitted by said communication electronics to detect an external device.

25. The interrogation reader of claim 19, further comprising at least one proximity sensor that is placed in proximity to said antenna array to detect said external device placed in proximity to at least one of said plurality of slots.

26. The interrogation reader of claim 25, wherein said proximity sensor is comprised from the group consisting of an optical sensor, an ultrasonic sensor, a microwave sensor, and a magnetic sensor.

27. The interrogation reader of claim 25, wherein said controller records an error condition if said proximity sensor detects said external device and said antenna array does not detect a wireless communication device attached to said external device.

28. The interrogation reader of claim 27, wherein said controller reports said error condition to reporting system.

29. The interrogation reader of claim 19, further comprising a proximity sensor that emits a signal to said controller and wherein said controller controls power to said communications electronics based on said signal.

30. The interrogation reader of claim 29, further comprising a number of proximity sensors equal to the number of said antennas in said antenna array wherein said each of said proximity sensor is placed in correlation to each of said antennas.

31. The interrogation reader of claim 12, wherein the interrogation reader communicates information concerning the wireless communication devices to reporting system.

32. The interrogation reader of claim 31, wherein said reporting system is located remote from the interrogation reader.

33. A cargo transportation communication system adapted to transport one or more objects having wireless communication devices, comprising:
a moveable arm adapted to carry one or more wireless communication devices;
an interrogation reader attached to said movable arm;
an antenna array attached to said moveable arm and aligned in the same direction as the objects; and
said interrogation reader coupled to said antenna array to form one or more antennas to communicate with said objects.

34. The system of claim 33, wherein said antenna array is a slot array.

35. The system of claim 34, wherein said slot array is comprised out of a plurality of slots.

36. The system of claim 33, wherein said antenna array is attached to one plane of said moveable arm.

37. The system of claim 36, wherein said antenna array is aligned in a vertical direction.

38. The system of claim 36, wherein said moveable arm is comprised from the group consisting of a forklift arm, a crane scoop, and a back-ho arm.

39. A forklift adapted to carry one or more stacked pallets containing wireless communication devices, comprising:
a body;
at least one moveable arm that moves with respect to said body and is attached to said body to carry the pallets;
a interrogation reader attached to one of said at least moveable one arm; and
an antenna array attached to said one of said at least one moveable arm;
said interrogation reader coupled to said antenna array to form one or more antennas to communicate with the stacked pallets.

40. The forklift of claim 39, wherein antenna array is a slot array consisting of a conductive section having a plurality of slots aligned in a vertical direction.

41. A method of communicating with stacked objects containing wireless communication devices, comprising the steps of:
activating a switch to provide a coupling to at least antenna in an antenna array;
exciting said at least antenna with energy; and
radiating the energy from said at least antenna to the stacked objects.

42. The method of claim 41, wherein said exciting further comprises providing a low energy to said at least one antenna to determine if the stacked object is present proximate to said at least one antenna.

43. The method of claim 42, wherein said exciting further comprises providing a high energy to said at least antenna to communicate to the stacked object that is determined to be located proximate to said at least one antenna.

44. The method of claim 41, further comprising receiving back reflected radiated energy from the staked object to determine if a stacked object is located proximate to said at least one antenna.

45. The method of claim 44, further comprising determining the height of the stacked objects by comparing the energy radiated to the stacked object device to the energy received back from the stacked object.

46. The method of claim 41, wherein said activating a switch comprises addressing said at least one antenna to select said at least one antenna for said exciting step.

47. A method of communicating with stacked objects containing a wireless communication device, comprising the steps of:
sensing the height of the stacked objects using a proximity sensor; and
exciting a number of antennas in an antenna array arranged in relation to the height of the stacked objects to communicate to the wireless communication devices on the stacked objects.

48. The method of claim 47, further comprising receiving communication back from the wireless communication devices.

49. The method of claim 48, further comprising recording an error condition if the wireless communication device does not communicate in response to the radiated energy.

50. The method of claim 49, further comprising reporting said error condition to reporting system.

51. The method of claim 49, further comprising reporting said error condition over a network to a remote system.

52. A method of determining the height of stacked objects containing wireless communication devices, comprising the steps of:
(a) selecting a first slot in a plurality of slots aligned in a vertical direction;
(b) radiating energy from said selected slot to the wireless communication device;
(c) receiving a signal from the wireless communication device in response to the radiated energy; and
(d) selecting the next slot in said plurality of slots and repeat steps (b)-(c) for each said next slot until all slots in said plurality of slots are selected.
